(19) United States
(12) Patent Application Publication
(10) Pub. No.: US 2025/0264495 A1
(43) Pub. Date: Aug. 21, 2025

(54) CAPACITIVE SENSING SYSTEM

(71) Applicant: Texas Instruments Incorporated, Dallas, TX (US)

(72) Inventors: Eslam Abdelbadie, Oslo (NO); Danielle Griffith, Richardson, TX (US); Jan-Tore Marienborg, Oslo (NO)

(21) Appl. No.: 18/442,791

(22) Filed: Feb. 15, 2024

(51) Int. Cl. G01P 15/125

(52) U.S. Cl. CPC G01P 15/125

(57) ABSTRACT

A capacitive sensing system may include a capacitive sensor and a sensing circuit. The sensing circuit may include an excitation circuit, a monitoring circuit, and a control circuit. The excitation circuit may provide a first signal of a first frequency and a second signal of a second frequency to the capacitive sensor to generate a third signal. The monitoring circuit may receive the third signal and generate an output signal based on the third signal. Based on the output signal from the monitoring circuit, the control circuit may control the first frequency of the first signal and/or the second frequency of the second signal to determine a value of the third signal.

### TECHNICAL FIELD

This disclosure generally relates to sensors, and in particular, to capacitive sensor based sensing systems.

### BACKGROUND

Capacitive sensors can be used in many applications. For example, in the automotive industry, capacitive accelerometers can be installed in a tire-pressure monitoring system (TPMS) to measure acceleration of an automotive. The measurement can further be used to implement functions such as automotive airbags, navigation, and instrumentation. In another example, capacitive sensors can be used to implement capacitive transducers in microphones for audio equipment to convert sound to electrical signals. Capacitive sensors perform the functions based on detecting a change in capacitance within the sensors caused by external force. Traditionally, a capacitive sensing system can have noise and jitter issues, which affect its sensing sensitivity and reliability. Further, sometimes capacitive sensors can have a long shelf time before putting in use, and thus low power and low leakage current while idle can be required. Thus, it is desired to have a low-noise and low-power solution for capacitive sensing.

### SUMMARY

This disclosure describes a capacitive sensor based sensing system (hereinafter “capacitive sensing system”). In some examples, the capacitive sensing system may include a sensing circuit and a capacitive sensor. The sensing circuit may provide excitation signals to modulate the capacitive sensor, and in response the capacitive sensor may generate an output signal. Based on the output signal, the sensing circuit may determine a change in capacitance of the capacitive sensor. The information may further be provided to a processor to implement other application-specific functions. In particular, in some examples, the frequency of the excitation signals may be controllably varied by the sensing circuit, instead of being held at a constant value, to determine the value of the output signal. For example, in some examples, the output signal may be compared with a reference signal, e.g., by a comparator, to generate a signal, e.g., a digital signal having a binary value. The value may indicate a result of the comparison, e.g., whether the output signal is less than, or not less than, the reference signal. For purposes of illustration, when the output signal becomes not less than the reference signal, the comparator may be considered “triggered,” whereas when the output signal is less than the reference signal, the comparator may be considered “untriggered.” Thus, when the comparator is triggered, the sensing circuit may determine that the value of the output signal is equal to, or at least not less than, the value of the reference signal. In some examples, the sensing circuit may iteratively change the frequency of the excitations signals back and forth. In turn, the change of the excitation frequency may change the output signal and thus repeatedly trigger and untrigger the comparator. As a result, the sensing circuit may iteratively narrow the range of the varied frequency to determine a closest frequency that triggers the comparator at the value of the reference signal. In other words, the sensing circuit may determine the value of the output signal (e.g., equal to the value of the reference signal) and the corresponding closest frequency at which the capacitive sensor is excited to generate the output signal of the same value as the reference signal. In some examples, for example, for a capacitive accelerometer, the output signal may be a function of acceleration (to be measured) at any specific excitation frequency. Thus, given the closest excitation frequency and the determined value of the output signal, the sensing circuit may further determine a value of the acceleration. The variation of the excitation frequency may create an extra control freedom to improve performance of the capacitive sensing system. For example, in some examples, by lowering the frequency, the output voltage-to-change of capacitance ratio (also called the “gain”) of the capacitive sensing system may be increased, which may thus increase the signal-to-noise ratio (SNR) to mitigate noise and jitter effects.

In some examples, the sensing circuit may include an excitation circuit, a monitoring circuit, and a control circuit. The excitation circuit may include a first output terminal and a second output terminal. The excitation circuit may be configured to provide a first signal of a first frequency to the capacitive sensor via the first output terminal, and a second signal of a second frequency to the capacitive sensor via the second output terminal. In some examples, the first frequency may be the same as the second frequency, and the first signal may have a phase shift relative to the second signal. In some examples, the phase shift may be 180 degrees, or in other words, the first signal may be out of phase relative to the second signal. In some examples, the monitoring circuit may include an input terminal configured to receive a third signal generated from the capacitive sensor in response to the first and second signals. In some examples, the control circuit may be configured to control the first frequency of the first signal and/or the second frequency of the second signal to determine a value of the third signal.

In some examples, a method for performing sensing based on a capacitive sensor may include providing a first signal of a first frequency and a second signal of a second frequency to a capacitive sensor to generate a third signal. In some examples, the first frequency may be equal to the second frequency, and the first signal may have a phase shift relative to the second signal. In some examples, the phase shift may be 180 degrees, or in other words, the first signal may be out of phase relative to the second signal. The method may further include receiving the third signal from the capacitive sensor (which is generated by the capacitive sensor in response to the first and second signals). The method may further include controlling the first frequency of the first signal and/or the second frequency of the second signal to determine a value of the third voltage.

In some examples, a device may include a sensing circuit configured to determine acceleration based on a capacitive sensor. In some examples, the sensing circuit may provide a first signal of a first frequency and a second signal of a second frequency to a capacitive sensor to generate a third signal. The sensing circuit may adjust the first frequency and/or the second frequency, which may in turn change the third signal. The sensing circuit may generate an output signal based on a reference signal and the third signal. The sensing circuit may determine whether to conclude adjustment of the first and/or second frequencies based on the output signal, and in response to determining to conclude adjustment of the first and/or second frequencies, determine values of the third signal, the first frequency, and/or the second frequency. The sensing circuit may determine a value of acceleration based on the values of the third signal, the first frequency, and/or the second frequency.

In some examples, a method for determining acceleration based on a capacitive sensor may include providing a first signal of a first frequency and a second signal of a second frequency to a capacitive sensor to generate a third signal. The method may include adjusting the first frequency and/or the second frequency, which may in turn change the third signal. The method may include generating an output signal based on a reference signal and the third signal. The method may include determining whether to conclude adjustment of the first and/or second frequencies based on the output signal, and in response to determining to conclude adjustment of the first and/or second frequencies, determining values of the third signal, the first frequency, and/or the second frequency. The method may include determining a value of acceleration based on the values of the third signal, the first frequency, and/or the second frequency.

These and other features and implementations will be better understood from the following detailed description with reference to the accompanying drawings.

### BRIEF DESCRIPTION OF THE DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 is a block diagram illustrating an example capacitive sensing system, according to some examples.

FIG. 2 is a diagram illustrating an example relationship between output signal and excitation frequency of a capacitive sensor at different acceleration, according to some examples.

FIG. 3 is a block diagram illustrating an example capacitive sensing system in more detail, according to some examples.

FIG. 4 is a block diagram illustrating an example monitoring circuit, according to some examples.

FIG. 5 is a diagram illustrating an example relationship between output signal and acceleration of a capacitive sensor, according to some examples.

FIG. 6 is a block diagram illustrating an example excitation circuit, according to some examples.

FIG. 7 is a flowchart illustrating an example method for performing sensing based on a capacitive sensor, according to some examples.

FIG. 8 is a flowchart illustrating an example method for performance sensing of acceleration based on a capacitive sensor, according to some embodiments.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the description or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

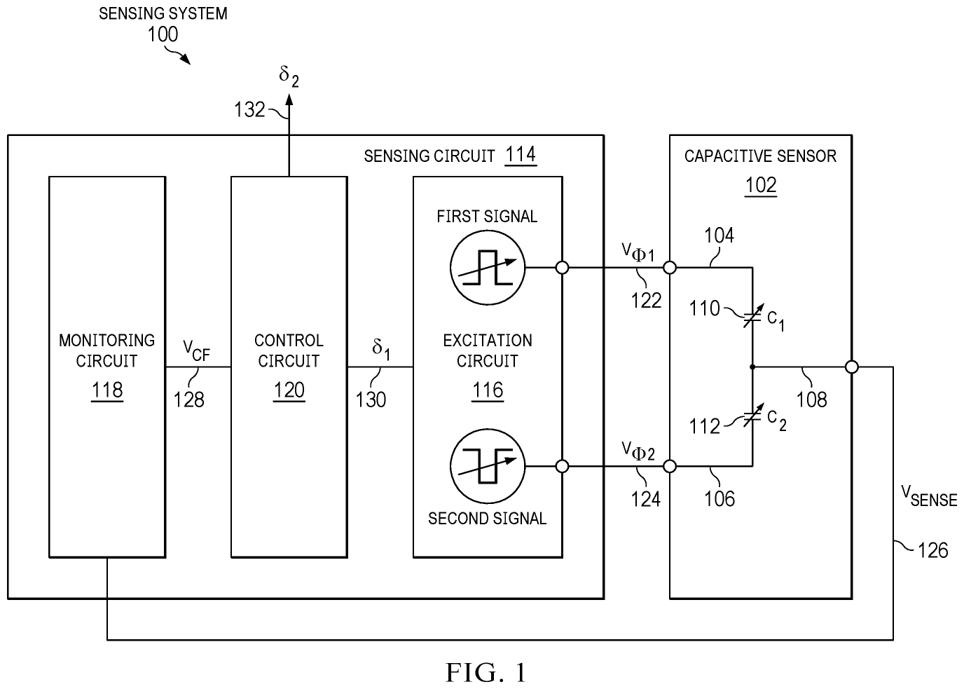

FIG. 1 is a block diagram illustrating an example capacitive sensing system, according to some examples. As shown in FIG. 1, in some examples, capacitive sensing system 100 may include capacitive sensor 102 and sensing circuit 114. For purposes of illustration, in FIG. 1, capacitive sensor 102 is represented by a simplified model including three conductive plates, e.g., top plate 104, middle plate 108, and bottom plate 106. In some examples, the three conductive plates may be arranged substantially in parallel to create top capacitor C1 110 between top plate 104 and middle plate 108, and bottom capacitor C2 112 between middle plate 108 and bottom plate 106. In some examples, top plate 104 and bottom plate 106 may be arranged to stay stationary, whereas middle plate 108 may be movable, or vice versa. Thus, external force may cause a displacement in distance between top plate 104 and middle plate 108, and a displacement in distance between middle plate 108 and bottom plate 106. The displacements may change capacitance of top capacitor C1 110 and bottom capacitor C2 112. In some examples, in equilibrium the capacitance of the two capacitors may be the same, whereas during movements the two capacitance may move in an opposite direction with the summation of the capacitance being a constant value. Note that FIG. 1 is provided only as an example for purposes of illustration. In some examples, capacitive sensor 102 may include more sets of plates beyond plates 104, 106, and 108. Thus, the capacitance formed by each pair of plates may appear in parallel and/or series to each other, allowing for a better resolution for measurement.

As shown in FIG. 1, in some examples, sensing circuit 114 may include excitation circuit 116, monitoring circuit 118, and control circuit 120. In some examples, excitation circuit 116 may generate first signal Φ₁ and second signal Φ₂. In some examples, Φ₁ and Φ₂ may be repetitive voltage signals V_{Φ1} 122 and V_{Φ2} 124 having respectively a first frequency and a second frequency. For example, V_{Φ1} 122 and V_{Φ2} 124 may be pulse-shaped voltage signals, sinusoidal voltage signals, etc. In some examples, the first frequency of V_{Φ1} 122 may be equal to the second frequency of V_{Φ2} 124. Additionally, in some example, V_{Φ1} 122 may have a phase shift relative to V_{Φ2} 124. In some examples, the phase shift may be 180 degrees, or in other words, V_{Φ1} 122 may be out of phase relative to V_{Φ2} 124. Moreover, in some examples, V_{Φ1} 122 may have the same amplitude as V_{Φ2} 124. Alternatively, in some examples, the first frequency may be different from the second frequency, the phase shift may be different other than 180 degrees, and/or the two signals may have different amplitudes.

As shown in FIG. 1, in some examples, excitation circuit 114 may have a first output terminal and a second terminal. Additionally, capacitive sensor 102 may have a first input terminal, a second input terminal, and an output terminal. The first input terminal of capacitive sensor 102 may be coupled to top plate 104, the second input terminal may be coupled to bottom plate 106, and the output terminal may be coupled to middle plate 108. In other words, capacitive sensor 102 may include top capacitor C1 110 between the first input terminal and the output terminal, and bottom capacitor C2 112 between the output terminal and the second input terminal. In some examples, excitation circuit 114 may inject first voltage signal V_{Φ1} 122 through the first output terminal to the first input terminal of capacitive sensor 102, and second output signal V_{Φ2} 124 through the second output terminal to the second input terminal of capacitive sensor 102. V_{Φ1} 122 and V_{Φ2} 124 may serve as excitation to stimulate capacitive sensor 102, which may in response generate an output signal, e.g., output voltage Vₛₑₙₛₑ 126, through the output terminal of capacitive sensor 102. As described above, external force, e.g., caused by acceleration, may change the capacitance of top capacitor C1 110 and bottom capacitor C2 112, which may in turn be reflected in output voltage Vₛₑₙₛₑ 126. Additionally, variation in the frequency of excitation signals V_{Φ1} 122 and V_{Φ2} 124 may also change output voltage Vₛₑₙₛₑ 126. Thus, given output voltage Vₛₑₙₛₑ 126 and excitation frequency, the corresponding acceleration may be determined. In some examples, the frequency of excitation signals V_{Φ1} 122 and V_{Φ2} 124 may be controlled to increase output voltage Vₛₑₙₛₑ 126 to thus increase the output voltage-to-change of capacitance ratio or gain of capacitive sensing system 100.

Referring back to FIG. 1, in some examples, monitoring circuit 118 may receive output voltage Vₛₑₙₛₑ 126 from capacitive sensor 102, which is generated by capacitive sensor 102 in response to excitation signals V_{Φ1} 122 and V_{Φ2} 124. In some examples, monitoring circuit 118 may generate signal V_{CF} 128 based on output voltage Vₛₑₙₛₑ 126 with a reference signal e.g., a reference voltage V_{REF}. For example, in some examples, monitoring circuit 118 may include a comparison circuit that may compare output voltage Vₛₑₙₛₑ 126 with V_{REF} to generate V_{CF} 128. Thus, V_{CF} 128 may indicate whether output voltage Vₛₑₙₛₑ 126 is less than, or not less than, V_{REF}. In some examples, monitoring circuit 118 may use V_{CF} 128 to monitor the change of Vₛₑₙₛₑ 126 in response to variation of the first frequency of V_{Φ1} 122 and/or the second frequency of V_{Φ2} 124. For purposes of illustration, when Vₛₑₙₛₑ 126 becomes not less than V_{REF}, the comparison circuit may be considered “triggered,” whereas when Vₛₑₙₛₑ 126 is less than V_{REF}, the comparison circuit may be considered “untriggered.” Thus, triggering of the comparison circuit implies that Vₛₑₙₛₑ 126 is equal to, or at least not less than, V_{REF}, and untriggering of the comparison circuit implies that Vₛₑₙₛₑ 126 is less than V_{REF}.

As shown in FIG. 1, in some examples, control circuit 120 may receive output signal V_{CF} 128 from monitoring circuit 118, which is generated based on output voltage Vₛₑₙₛₑ 126. As described above, in some examples, variation of the first frequency of V_{Φ1} 122 and/or the second frequency of V_{Φ2} 124 may cause a change to output voltage Vₛₑₙₛₑ 126, which may further cause a change to V_{CF} 128. For example, the variation of the first and/or second frequencies may increase or decrease Vₛₑₙₛₑ 126, which may trigger or untrigger the comparison circuit of monitoring circuit 118. This may be represented by V_{CF} 128. In some examples, control circuit 120 may iteratively change (through excitation circuit 114) the first and/or second frequencies back and forth. In turn, the change of the first and/or second frequencies may repeatedly trigger and untrigger the comparison circuit. Thus, based on V_{CF} 128, control circuit 120 may iteratively narrow the range of the first and/or second frequencies to determine closest first and/or second frequencies that trigger the comparison circuit at the value of V_{REF}. In other words, control circuit 120 may determine the value of Vₛₑₙₛₑ 126 (e.g., equal to the value of V_{REF}) and the corresponding closest first and/or second frequencies at which capacitive sensor 102 generates Vₛₑₙₛₑ 126 of the same value as V_{REF}. In some examples, for example, for a capacitive accelerometer, Vₛₑₙₛₑ 126 may be a function of acceleration (to be measured) at any specific excitation frequencies. Thus, given the determined value of Vₛₑₙₛₑ 126 and first and/or second frequencies, control circuit 120 may further determine a value of acceleration.

In some examples, control circuit 120 may provide δ₁ 130 to excitation circuit 116 to control the first frequency of first excitation signal V_{Φ1} 122 and/or the second frequency of second excitation signal V_{Φ2} 124. For example, excitation circuit 116 may include an oscillator and a divisor. Excitation circuit 114 may divide a clock signal generated from the oscillator by the divisor to generate a divided clock signal, which may further be used to generate V_{Φ1} 122 and V_{Φ2} 124. Accordingly, δ₁ 130 may indicate a value or change to the value of the divisor. Thus, by providing δ₁ 130 to excitation circuit 116, control circuit 120 may adjust the frequencies of V_{Φ1} 122 and/or V_{Φ2} 124. In another example, excitation circuit 114 may include a relaxation oscillating circuit configured to generate V_{Φ1} 122 and V_{Φ2} 124, where the frequencies of V_{Φ1} 122 and V_{Φ2} 124 may depend on values of a set of resistors. Accordingly, δ₁ 130 may indicate a value or change to the value of at least one of the resistors, and accordingly the frequencies of V_{Φ1} 122 and/or V ₁₂ 124 may be adjusted by control circuit 120.

As shown in FIG. 1, in some examples, control circuit 120 may provide signal δ₂ 132 to a processor (not shown). For example, as described above, if capacitive sensor 102 is a capacitive accelerometer for a TPMS of an automotive, control circuit 132 may determine a value of acceleration. Thus, δ₂ 132 may include the determined value of acceleration. In response to receiving δ₂ 132, the processor may implement other functions such as automotive airbags, navigation, and instrumentation. In some examples, the processor or control circuit 120 of sensing circuit 114 may identify an “optimal” frequency amongst the varied first and/or second frequencies to operate capacitive sensor 102. In practice, different capacitive sensors may have different properties and thus require different optimal frequencies to operate. Thus, sensing circuit 114 may be fit for various sensor by automatically adjusting excitation signals for optimal performance when used with those sensors.

In some examples, sensing circuit 114 may be configured to operate in a regular mode and a relatively low power mode. In some examples, sensing circuit 114 may self-determine whether to switch from the regular mode to the low power mode. For example, sensing circuit 114 may determine that no acceleration and/or no change of acceleration is detected within a certain time period (e.g., during idle), and thus switch to the low power mode to save energy for the system. Alternatively, in some examples, switching of modes may be controlled by external signal(s). For example, a processor may provide a trigger signal to enable the low power mode or wake up sensing circuit 114 from the low power mode to the regular mode.

In some examples, sensing circuit 114 may be implemented using an integrated circuit (IC) or a system on a chip (SOC). Additionally, in some examples, capacitive system 100, including both capacitive sensor 102 and sensing circuit 114, may be integrated into one IC or SOC. Further, in some examples, capacitive sensor 102 may be a micro-electromechanical system (MEMS) capacitive accelerometer, and sensing circuit 112 may be the corresponding sensing circuit, both of which may be associated with a TPMS of an automotive.

The disclosed sensing system may provide at least several benefits. For example, traditionally a sensing circuits injects only one single excitation signal at a constant frequency to modulate a capacitive sensor. By comparison, sensing circuit 114 as disclosed herein may provide two excitation signals V_{Φ1} 122 and V_{Φ2} 124 of variable frequencies to modulate a capacitive sensor. As described above, the variation of the frequencies of the excitation signals may create extra control freedom to increase the gain and SNR of the capacitive sensing system and thus reduce the noise and jitter effects. Additionally, as described above, sensing system 100 with the self-tuning capability may be used with different capacitive sensors, requiring minimum adjustments by customers. For example, in some examples, sensing circuit 114 may sweep the frequencies of V_{Φ1} 122 and V_{Φ2} 124 within a range to cause capacitive sensor 102 to generate output signal Vₛₑₙₛₑ 126 at different excitation frequencies. For a given capacitive sensor, the information may be processed to identify an optimal excitation frequency to operate the sensor.

Note that FIG. 1 is provided only as an example for purposes of illustration. In some examples, sensing circuit 114 may provide only one signal of a variable frequency to modulate capacitive sensor 102. For example, sensing circuit 114 may inject one single variable-frequency excitation voltage to middle plate 108 of capacitive sensor 102 and measure the output voltage generated between top plate 104 and bottom plate 106. The remaining operations of sensing circuit 114 may be similar to what is described above. For example, the output signal may be received by monitoring circuit 116 which may generate an output signal (e.g., from comparison) based on the output signal of the capacitive sensor. Based on the output signal of the monitoring circuit, control circuit 118 may control the frequency of the excitation voltage to determine a value of the output signal of the capacitive sensor. Additionally, in some examples, besides the above described frequency modulation, sensing circuit 114 may modulate the amplitude(s) and/or phase(s) of the excitation signal(s) to perform measurement based on capacitive sensor 102. Moreover, sensing circuit 114 may also apply to an inductive sensor. For examples, in some examples, sensing circuit 114 may inject one or more variable-frequency excitation signals to modulate an inductive sensor, which may in response generate an output signal. Sensing circuit 114 may receive the output signal and control the frequencies of the excitation signals to determine a value of the output signal of the inductive sensor.

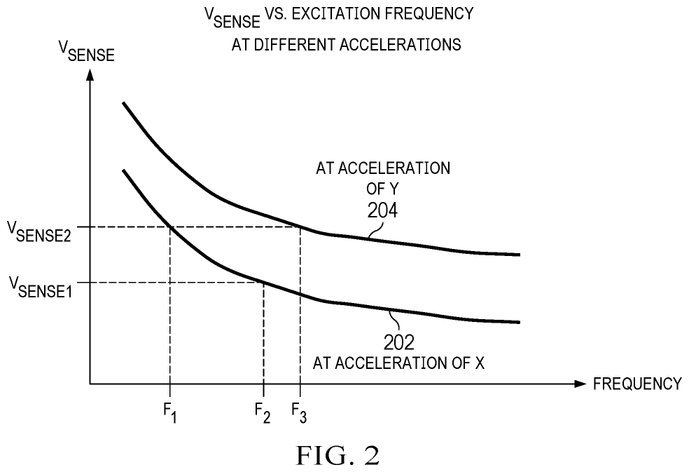

FIG. 2 is a diagram illustrating an example relationship between output signal and excitation frequency of a capacitive sensor at different acceleration, according to some examples. In FIG. 2, the horizontal axis represents the frequency of excitation signals (e.g., V_{Φ1} 122 and V_{Φ2} 124, assuming that the two signals have the same frequency), and the vertical axis represents the value of an output signal of a capacitive sensor (e.g., Vₛₑₙₛₑ 126 of capacitive sensor 102). In FIG. 2, curve 202 represents the output signal at a first acceleration of x, whereas curve 204 represents the output signal at a second acceleration of y. As shown by curve 202, at one given acceleration (e.g., acceleration of x), the output signal may change monotonically with the excitation frequency. In particular, when the excitation frequency decreases, e.g., from F₂ to F₁, the value of the output signal increases, e.g., from V_{SENSE1} to V_{SENSE2}. In other words, in some examples, lowering the excitation frequency may increase the output signal and thus the gain of a capacitive sensing system. Thus, the output signal may be considered a function of the excitation frequency. Adjustment of the excitation frequency may cause a change to the output signal. Further, as shown by curves 202 and 204, at different acceleration, e.g., from x to y, the output signal, e.g., V_{SENSE2}, corresponds to different excitation frequencies, e.g., F₁ and F₃. Thus, acceleration may be considered a function of the output signal and excitation frequency. Accordingly, by determining the output signal and excitation frequency, the acceleration may be determined.

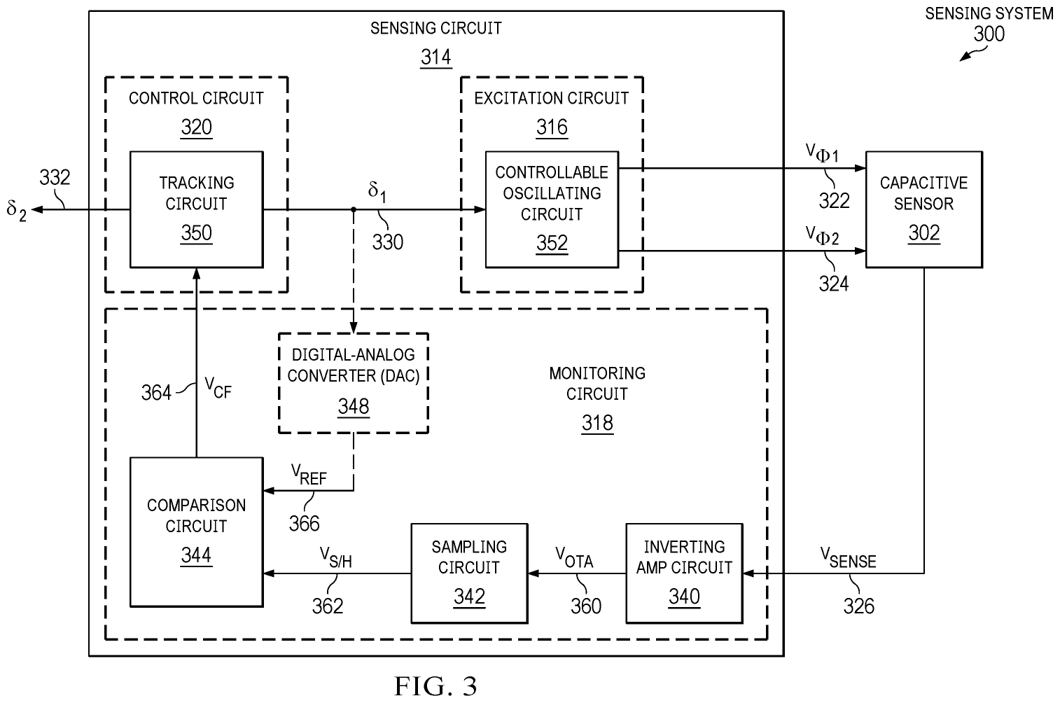

FIG. 3 is a block diagram illustrating an example capacitive sensing system in more detail, according to some examples. As shown in FIG. 3, capacitive sensing system 300 may include capacitive sensor 302 and sensing circuit 314. In some examples, capacitive sensor 302 may be similar to capacitive sensor 102 described above in FIG. 1. For example, capacitive sensor 302 may include a first capacitance (e.g., capacitance of top capacitor C1 110), e.g., between a first input terminal and an output terminal, and a second capacitance (e.g., capacitance of bottom capacitor C2 112), e.g., between the output terminal and a second input terminal.

In some examples, sensing circuit 314 may be similar to sensing circuit 114 described above in FIG. 1. For example, as shown in FIG. 3, sensing circuit 314 may also include excitation circuit 316 (similar to excitation circuit 116), monitoring circuit 318 (similar to monitoring circuit 118), and control circuit 320 (similar to control circuit 120). In some examples, excitation circuit 316 may include controllable oscillating circuit 352, which may generate first excitation signal V_{Φ1} 322 of a first signal and second excitation signal V_{Φ2} 324 of a second signal. For example, controllable oscillating circuit 352 may include an oscillator and a divisor. The oscillator may generate a clock signal at a constant frequency, and the divisor may have a controllably variable value. Controllable oscillating circuit 352 may divide the clock signal by the divisor to generate a divided clock signal, and generate V_{Φ1} 322 and V_{Φ2} 324 based on the divided clock signal. Thus, by varying the value of the divisor, controllable oscillating circuit 352 may vary the frequencies of V_{Φ1} 322 and V_{Φ2} 324. In another example, controllable oscillating circuit 352 may include a relaxation oscillating circuit configured to generate V_{Φ1} 322 and V_{Φ2} 324, where the frequencies of V_{Φ1} 322 and V_{Φ2} 324 may depend on values of a set of resistors of the relaxation oscillating circuit. Thus, controllable oscillating circuit 352 may adjust the frequencies of V_{Φ1} 322 and V_{Φ2} 324 by varying the values of the resistors. In some examples, excitation circuit 316 may provide V_{Φ1} 322 and V_{Φ2} 324 to capacitive sensor 302, which may in response generate output signal Vₛₑₙₛₑ 326. In some examples, V_{Φ1} 322 and V_{Φ2} 324 may have the same frequency and amplitude, and V_{Φ1} 322 may be phase shifted relative to V_{Φ2} 324. In some examples, the phase shift may be 180 degrees, or in other words, V_{Φ1} 322 may be out of phase relative to V_{Φ2} 324. Alternatively, in some examples, V_{Φ1} 322 and V_{Φ2} 324 may have different frequencies and/or amplitudes, and the phase shift may be different from 180 degrees.

As shown in FIG. 3, in some examples, monitoring circuit 318 may include inverting amplification circuit 340, sampling circuit 342, and comparison circuit 344. In some examples, monitoring circuit 318 may optionally (as shown by the dashed lines) include digital-to-analog converter (DAC) 348. As the name implies, in some examples, inverting amplification circuit 340 may receive output signal Vₛₑₙₛₑ 326 and generate output signal V_{OTA} 360, which may be an amplified version of Vₛₑₙₛₑ 326 with an opposite phase. Note that FIG. 3 is provided only as an example for purposes of illustration. In some examples, monitoring circuit 318 may use a non-inverting amplification circuit, which may amplify Vₛₑₙₛₑ 326 without the phase opposite. As shown in FIG. 3, in some examples, sampling circuit 342 may receive output signal V_{OTA} 360 from inverting amplification circuit 340 and generate a sample of V_{OTA} 360, e.g., V_{S/H} 362, during each sampling period. In some examples, comparison circuit 344 may receive V_{S/H} 362 and a reference signal V_{REF} 366, and generate signal V_{CF} 364 based on comparison between V_{S/H} 362 and V_{REF} 366. In some examples, V_{CF} 364 may indicate which one of V_{S/H} 362 and V_{REF} 366 is larger. For example, in some examples, V_{CF} 364 may have a binary value, where one binary value (e.g., a binary one) indicates that V_{S/H} 362 is not less than V_{REF} 366 and the other binary value (e.g., a binary zero) indicates that V_{S/H} 362 is less than V_{REF} 366. For purposes of illustration, comparison circuit 344 may be considered “triggered” when V_{S/H} 362 is not less than V_{REF} 366, and “untriggered” when V_{S/H} 362 is less than V_{REF} 366. As shown in FIG. 3, in some examples, V_{REF} 366 may have a constant value, e.g., provided by a given voltage source. Alternatively, in some examples, V_{REF} 366 may be provided by DAC 348, which may be varied by control circuit 320 (as described below).

Referring back to FIG. 3, in some examples, control circuit 320 may include tracking circuit 350. In some examples, tracking circuit 350 may receive V_{CF} 364, and based on V_{CF} 364, control the frequencies of V_{Φ1} 322 and/or V_{Φ2} 324 to determine the value of Vₛₑₙₛₑ 326. For example, as described above, V_{CF} 364 may be generated based on comparison between V_{S/H} 362 (which represents Vₛₑₙₛₑ 326) and V_{REF} 366. Further, as described above in FIG. 2, Vₛₑₙₛₑ 326 may be changed by adjustment of the frequencies of V_{Φ1} 322 and/or V_{Φ2} 324. Thus, based on V_{CF} 364, tracking circuit 350 may control the frequencies of V_{Φ1} 322 and/or V_{Φ2} 324 to search for the closest excitation frequencies that cause capacitive sensor 302 to generate Vₛₑₙₛₑ 326 of the same value as V_{REF} 366. Since the value of V_{REF} 366 is known to tracking circuit 350, at conclusion of the search, tracking circuit 350 may accordingly determine the value of Vₛₑₙₛₑ 326 and the corresponding excitation frequencies.

For example, referring to FIGS. 2 and 3, consider that capacitive sensing system 300 operates at the acceleration of x, and V_{REF} 366 has a value between V_{SENSE1} and V_{SENSE2} corresponding to an excitation frequency F₄ (assuming V_{Φ1} 322 and V_{Φ2} 324 have the same frequency). Additionally, to simplify explanation, consider that V_{SENSE} 326 is not amplified (e.g., V_{S/H} 362 is equal to V_{SENSE} 326 directly). At beginning, excitation circuit 316 may generate V_{Φ1} 322 and V_{Φ2} 324 at the frequency F₂. In response, capacitive sensor 302 may generate Vₛₑₙₛₑ 326 of value V_{SENSE1}. As shown in FIG. 2, V_{SENSE1} is less than V_{REF} 366. Thus, comparison circuit 344 may be untriggered (indicated by V_{CF} 364). Since comparison circuit 344 is untriggered, tracking circuit 350 may determine that Vₛₑₙₛₑ 326 is less than V_{REF} 366.

Next, control excitation circuit 316 may lower the frequency of V_{Φ1} 322 and V_{Φ2} 324 from F₂ to F₁ to trigger comparison circuit 344. As described above, in some examples, lowering the frequency of V_{Φ1} 322 and V_{Φ2} 324 may increase output signal Vₛₑₙₛₑ 326. Thus, Vₛₑₙₛₑ 326 may increase from V_{SENSE1} (at F₂) to V_{SENSE2} (at F₁). Because V_{SENSE2} is larger than V_{REF} 366, comparison circuit 364 may be triggered (also indicated by V_{CF} 364). Accordingly, tracking circuit 350 may determine that Vₛₑₙₛₑ 326 is no less than V_{REF} 366.

Next, tracking circuit 350 may adjust the frequency of V_{Φ1} 322 and V_{Φ2} 324 in the opposite direction to untrigger comparison circuit 344. For example, tracking circuit 350 may increase (e.g., step by step) the frequency of V_{Φ1} 322 and V_{Φ2} 324 from F₁ until comparison circuit 344 is re-untriggered at frequency F₅. Thus, compared to F₁, F₅ is less than F₁ and thus closer to F₄ (the excitation frequency corresponding to V_{REF} 366) than F₁.

Next, tracking circuit 350 may reverse the adjustment direction once again to decrease (e.g., step by step) the frequency of V_{Φ1} 322 and V_{Φ2} 324 from F₅, until comparison circuit 344 is re-triggered at frequency F₆. Similarly, F₆ is a frequency closer to F₄ than F₂.

In some examples, tracking circuit 350 may repeat the above searching process. Depending on the step change or resolution of adjustment of the frequency of V_{Φ1} 322 and V_{Φ2} 324, tracking circuit 350 may or may not be able to settle at exactly the frequency F₄. Regardless, tracking circuit 350 may be able to identify an excitation frequency that is closest to F₄ amongst the controllably available frequency of V_{Φ1} 322 and V_{Φ2} 324. Even though described for the acceleration of x, the above operation applies to measurement at different acceleration. As described above in FIG. 2, at different acceleration, the acceleration may be considered a function of output signal and excitation frequency. Thus, when values of output signal and excitation frequency are determined, the value of acceleration may be determined. For examples, in some examples, tracking circuit 350 may include a lookup table indicating the value of acceleration corresponding to different Vₛₑₙₛₑ and excitation frequencies. Thus, once values of Vₛₑₙₛₑ 326 and excitation frequency are determined, tracking circuit 3530 may access the lookup table to determine the corresponding acceleration.

Referring back to FIG. 3, in some examples, tracking circuit 350 may generate δ₁ 330 to represent values or changes to values of the frequencies of V_{Φ1} 322 and V_{Φ2} 324. As described above, in some examples, controllable oscillating circuit 352 (of excitation circuit 116) may use a divided clock signal to generate V_{Φ1} 322 and V_{Φ2} 324. Thus, in that case, δ₁ 330 may indicate a value or change to the value of the divisor. In another example, controllable oscillating circuit 352 may use a relaxation oscillating circuit to generate V_{Φ1} 322 and V_{Φ2} 324, where the frequencies of the V_{Φ1} 322 and V_{Φ2} 324 may depend on values of a set of resistors. Accordingly, in that case, δ₁ 330 may indicate a value or change to the value of at least one of the resistors.

As shown in FIG. 3, in some examples, monitoring circuit 318 may optionally (as shown by the dashed lines) include DAC 348. In some examples, DAC 348 may receive δ₁ 330 from tracking circuit 350, and based on δ₁ 330, generate the reference signal V_{REF} 366. Inclusion of DAC 348 may expedite convergence of the above described searching process to the closest excitation frequency, thus further improving performance of capacitive sensing system 314. For example, when tracking circuit 350 determines that comparison circuit 344 is untriggered (e.g., when V_{SENSE} 326 is less than V_{REF} 366), tracking circuit 350 may use DAC 348 to lower the value of V_{REF} 366 (e.g., by lowering the frequency represented by δ₁ 330) to accelerate triggering of comparison circuit 344. Conversely, when comparison circuit 344 is triggered, tracking circuit 350 may use DAC 348 to increase the value of V_{REF} 366 (e.g., by increasing the frequency represented by δ₁ 330) to speed up untriggering of comparison circuit 344. Controllability of V_{REF} 366 may create one more control freedom to result in expedited determination of values of V_{SENSE} 326 and/or acceleration.

As shown in FIG. 3, in some examples, tracking circuit 350 may generate signal δ₂ 332. As described above, for example, for a capacitive accelerometer, tracking circuit 350 may determine a value of acceleration. Thus, δ₂ 332 may be a digital signal representing the determined value of acceleration. In some examples, control circuit 320 may provide δ₂ 332 to a processor (not shown), which may implement other functions such as automotive airbags, navigation, and instrumentation. In some examples, the processor or control circuit 320 may identify an “optimal” frequency to operate capacitive sensor 302.

Note that FIG. 3 is provided only as an example for purposes of illustration. In some examples, tracking circuit 350 may use a variety of searching algorithm to look for the closest excitation frequency. For example, in some examples, tracking circuit 350 may adjust the frequency according to sequential searching (e.g., adjusting the frequency according to a predetermined sequence), successive approximation searching (e.g., adjusting the frequency based on the comparison result), delta-sigma, etc.

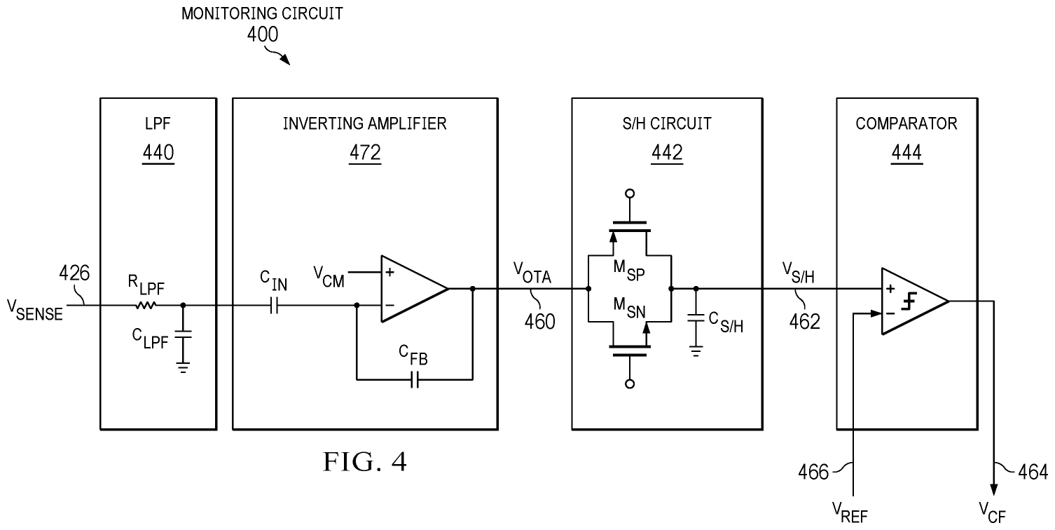

FIG. 4 is a block diagram illustrating an example monitoring circuit, according to some examples. As shown in FIG. 4, in some examples, monitoring circuit 400 may be similar to the monitoring circuits described above in FIGS. 1-3. For example, in some examples, monitoring circuit 400 may include low pass filter (LPF) 440, inverting amplifier 472, sampling circuit 442, and comparator 444. In some examples, LPF 440 may be formed by a resistor-capacitor (RC) circuit of R_{LPF} and C_{LPF}. LPF 440 may receive an output signal Vₛₑₙₛₑ 426 from a capacitive sensor at an input terminal, and generate filtered output signal Vₛₑₙₛₑ 426 at an output terminal. In some examples, inverting amplifier 472 may include an operational amplifier, an input capacitor C_{IN}, and a feedback capacitor C_{FB}. C_{IN} may be coupled to a negative (or inverting) input terminal of the operational amplifier, whereas C_{FB} may be coupled between the negative (or inverting) input terminal and an output terminal of the operational amplifier. In some examples, a common mode voltage V_{CM} (e.g., a DC voltage) may be provided to bias a positive (or non-inverting) input terminal of the operational amplifier and establish a DC operating point centered around the common mode voltage V_{CM}. For example, if the supply voltage of the operational amplifier is 1.5 V, the common mode voltage V_{CM} may be chosen as 800 mV to ensure sufficient and approximately equal room for voltages swings in either direction between 1.5 V and 0 V. This may provide the maximum readable range of V_{SENSE} 326. As shown in FIG. 4, LPF 440 may receive Vₛₑₙₛₑ 426, filter out high frequency components, and generate filtered output signal Vₛₑₙₛₑ 426. The filtered output signal Vₛₑₙₛₑ 426 may be provided to the negative (or inverting) input terminal of the operational amplifier via input capacitor C_{IN}, and output signal V_{OTA} 460 (representing an amplified version of Vₛₑₙₛₑ 426 with an opposite phase) may be generated at the output terminal of the operational amplifier. In some examples, input capacitor C_{IN} may provide AC coupling to the operational amplifier, thus increasing the input impedance of monitoring circuit 400 and reducing the capacitive sensing system's leakage current. This may help to achieve a lower power consumption especially at idle.

In some examples, sampling circuit 442 may include an input terminal and an output terminal. As shown in FIG. 4, sampling circuit 442 may receive output signal V_{OTA} 460 from inverting amplifier 472 at the input terminal of sampling circuit 442. In some examples, sampling circuit 442 may include a n-channel MOSFET (NFET) and a p-channel MOSFET (PFET) coupled between the input and output terminals of sampling circuit 442. The output terminal may further be coupled to a capacitor C_{S/H}. The NFET and PFET may respectively be controlled by their gate signals to turn on and thus connect the output terminal to V_{OTA} 460 of the input terminal. The capacitor C_{S/H} may hold V_{S/H} 462 to the levels of V_{OTA} 460 that the NFET or PFET passes through.

In some examples, comparator 444 may include a positive input terminal, a negative input terminal, and an output terminal. As shown in FIG. 4, in some examples, comparator 444 may receive V_{S/H} 462 at the positive input terminal, and reference signal V_{REF} 466 at the negative input terminal, and generate signal V_{CF} 464 at the output terminal. As described above, V_{CF} 464 may be provided to a tracking circuit of a control circuit (e.g., tracking circuit 350 of control circuit 320 in FIG. 3). Further, in some examples, V_{REF} 466 may have a constant value, e.g., provided by a given voltage source. Alternatively, in some examples, V_{REF} 466 may be generated by a DAC (e.g., DAC 348) under control of the tracking circuit.

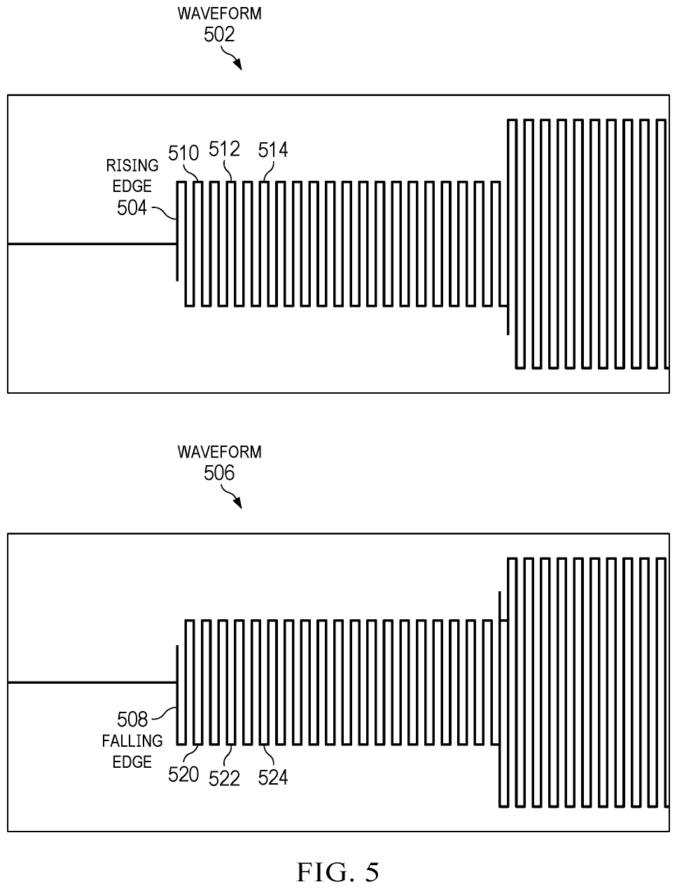

FIG. 5 is a diagram illustrating an example relationship between output signal and acceleration of a capacitive sensor, according to some examples. As shown in FIG. 5, waveforms 502 and 504 illustrate an output signal Vₛₑₙₛₑ of a capacitive sensor in response to excitation signals at acceleration of respectively different directions. As shown by waveform 502, output signal Vₛₑₙₛₑ increases when the acceleration increases from 0 g to 1 g and 2 g in a first direction, where 1 g equals to 9.8 m/s². As shown in FIG. 5, waveform 502 may include rising edge 504 at beginning. In some examples, a sampling circuit (e.g., the sampling circuits described above in FIGS. 3-4) may sample positive peaks 510, 512, 514, etc. of output voltage Vₛₑₙₛₑ. By comparison, waveform 504 illustrates output signal Vₛₑₙₛₑ when acceleration is in a second direction opposite to the first direction of waveform 502. As shown in FIG. 5, while Vₛₑₙₛₑ also increases with the acceleration (e.g., from 0 g to −1 g and −2 g), waveform 504 may include falling edge 508 at beginning. At the same points in time, the sampling circuit may sample negative peaks 520, 522, 524, etc. of output voltage Vₛₑₙₛₑ. Thus, based on the samples (especially the sign of the samples) of output signal Vₛₑₙₛₑ, a direction of the acceleration may be determined.

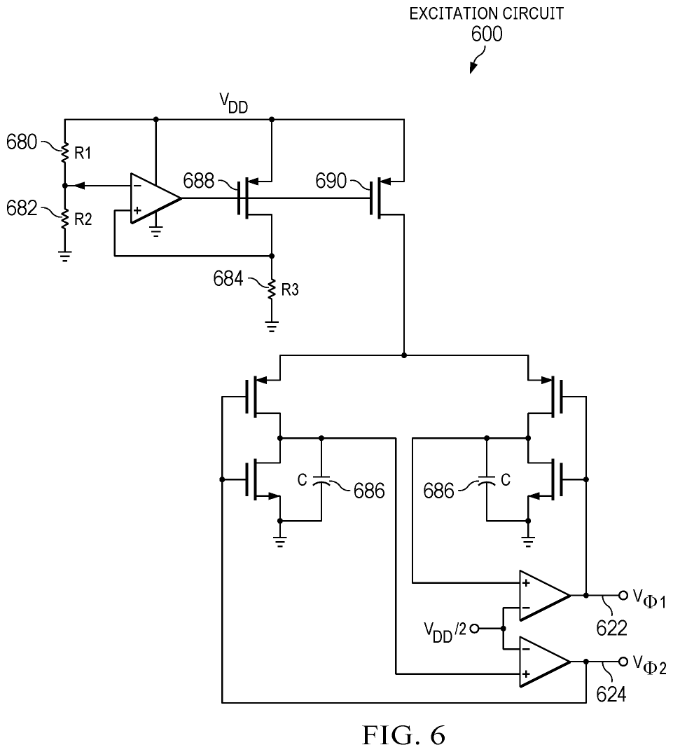

FIG. 6 is a block diagram illustrating an example excitation circuit, according to some examples. As shown in FIG. 6, in some examples, excitation circuit 600 may include a relaxation oscillating circuit configured to generate first voltage signal V_{Φ1} 622 and second voltage signal V_{Φ2} 624. In some examples, the frequencies of V_{Φ1} 622 and V_{Φ2} 624 may depend on at least resistors R₁ 680, R₂ 682, and R₃ 684. For example, adjustment of resistors R₁ 680, R₂ 682, and R₃ 684 change the gate voltages of PFETs 688 and 690, which in turn may affect charging and discharging of the two capacitors C 686. The charging and discharging of capacitors C 686 may further generate V_{Φ1} 622 and V_{Φ2} 624. In some examples, V_{Φ1} 622 and V_{Φ2} 624 may have the same frequency, and the two signals may be out of phase (e.g., a phase shift of 180 degrees) relative to each other. In some examples, the frequency of V_{Φ1} 622 and V_{Φ2} 624 may be determined by resistors R₁ 680, R₂ 682, R₃ 684, and capacitors C 686 according to the equation

$$f = \frac{{R}_{2}}{C ( {R}_{2} + {R}_{1} ) {R}_{3}} .$$

Thus, by adjusting at least one of resistors R₁ 680, R₂ 682, and R₃ 684, the frequency of V_{Φ1} 622 and V_{Φ2} 624 may be controlled. For example, in some examples, R₂ 682 may be a variable resistor, and by increasing the value of R₂ 682, the frequency of V_{Φ1} 622 and V_{Φ2} 624 may be reduced. As described above, in some examples, this may increase the gain of a capacitive sensing system. In some examples, R₂ 682 and R₃ 684 may be part of one integrated resistor (e.g., a potentiometer), such that the summation of R₂ 682 and R₃ 684 is a constant but the ratio between R₂ 682 and R₃ 684 is variable.

Note that FIG. 6 is provided only as an example for purposes of illustration. In some examples, excitation circuit 600 may use a variety of circuits to generate V_{Φ1} 622 and V_{Φ2} 624. For example, in some examples, excitation circuit 600 may include an oscillator and a divisor. Excitation circuit 600 may divide a clock signal (at a constant frequency) from the oscillator by the divisor to generate a divided clock signal, and generate V_{Φ1} 622 and V_{Φ2} 624 based on the divided clock signal. In that case, the frequencies of V_{Φ1} 622 and V_{Φ2} 624 may be adjusted by controlling a value of the divisor.

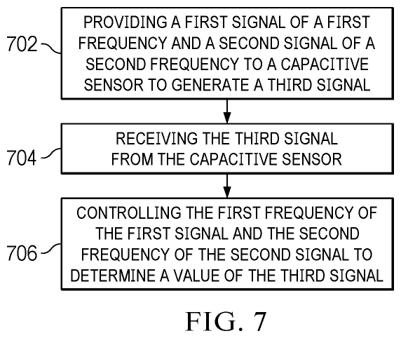

FIG. 7 is a flowchart illustrating an example method for performing sensing based on a capacitive sensor, according to some examples. As shown in FIG. 7, in some examples, a first signal of a first frequency and a second signal of a second frequency may be provided to a capacitive sensor to generate a third signal, as indicated by block 702. As described above, in some examples, the first and second signals may be excitation voltages generated by an excitation circuit of a sensing circuit of a capacitive sensing system. In some examples, the first frequency may be equal to the second frequency. Further, in some examples, the first signal may have a phase shift relative to the second signal. In some examples, the phase shift may be 180 degrees, or in other words, the first signal may be out of phase relative to the second signal.

As shown in FIG. 7, in some examples, the third signal from the capacitive sensor may be received, e.g., as indicated by block 704. As described above, in some examples, the third signal may be received by a monitoring circuit of the sensing circuit. In some examples, the monitoring circuit may generate an output signal based on the third signal. For example, the monitoring circuit may compare a signal representing the third signal (e.g., samples representing the third signal) with a reference signal to generate the output signal.

As shown in FIG. 7, in some examples, the first frequency of the first signal and/or the second frequency of the second signal may be controlled to determine a value of the third voltage, as indicated by block 706. As described above, the output signal from the monitoring circuit may be received by a control circuit of the sensing circuit. Based on the output signal, the control circuit may adjust the first frequency and/or the second frequency (iteratively) to search for the closest excitation frequencies. At conclusion of the adjustment, the control circuit may determine the value of the third signal based on a value of the reference signal.

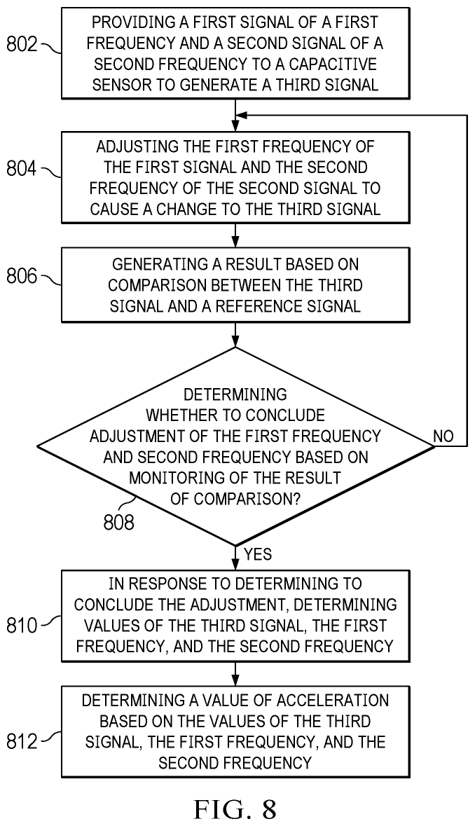

FIG. 8 is a flowchart illustrating an example method for performing sensing of acceleration based on a capacitive sensor, according to some examples. As shown in FIG. 8, in some examples, a first signal of a first frequency and a second signal of a second frequency may be provided to a capacitive sensor to generate a third signal, as indicated by block 802. In some examples, the first frequency and/or the second frequency may be adjusted to cause a change to the third signal, as indicated by block 804. As described above, in some examples, decreasing the first frequency and/or the second frequency may increase the third signal, whereas increasing the first frequency and/or the second frequency may decrease the third signal. Further, when acceleration changes, one value of the third signal may correspond to different first and/or second frequencies. In some examples, an output signal or a result may be generated based on the third signal and a reference signal, as indicated by block 806. For example, as described above, in some examples, the output signal may be generated based on comparison between the third signal and the reference signal. In some examples, it may be determined whether to conclude the adjustment of the first and/or second signal based on monitoring of the output signal, as indicated by block 808. For example, as described above, in some examples, based on the output signal, an iterative frequency adjustment may be performed to identify the closest first and/or second frequency for the capacitive sensor to generate the third signal of the same value as the reference signal. In some examples, in response to determining to conclude the frequency adjustment, values of the third signal, the first frequency, and/or the second frequency may be determined, as indicated by block 810. For examples, as described above, the value of the third signal may be determined based on a value of the reference signal, whereas the values of the first and/or second frequencies may be determined based on the above concluded frequency adjustment. In some examples, a value of acceleration may be determined based on the determined values of the third signal, the first frequency, and/or the second frequency, as indicated by block 812. For examples, as described above, a lookup table may indicate the value of acceleration corresponding to different values of the third signal, the first frequency, and/or the second frequency. Thus, based on the lookup table, the value of acceleration may be determined from the values of the third signal, the first frequency, and/or the second frequency.

As used herein, the term “circuit” can include a collection of active and/or passive elements that perform a circuit function, such as an analog circuit or control circuit. Additionally or alternatively, for example, the term “circuit” can include an integrated circuit (IC) where all and/or some of the circuit elements are fabricated on a common substrate (e.g., semiconductor substrate).

The control circuit described herein (e.g., control circuit 320) can be implemented as generic or custom processors (e.g., coupled to a memory) and configured to execution instructions stored in such memory. For example, the processors can include one or more, generic or custom, integrated circuits (ICs) (e.g., application-specific integrated circuits (ASICs)), logic circuits, microprocessors, field programmable gate arrays (FPGAs) that may instantiate instructions, central processor units (CPUs), graphic processor units (GPUs), digital signal processors (DSPs), or controllers. In some examples, the processors can include dedicated or general purpose circuitry, and the various processors may be combined or discrete circuitry.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Also, in this description, the recitation “based on” means “based at least in part on.” Therefore, if X is based on Y, then X may be a function of Y and any number of other factors.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal”, “node”, “interconnection”, “pin” and “lead” are used interchangeably. Unless specifically stated to the contrary, these terms are generally used to mean an interconnection between or a terminus of a device element, a circuit element, an integrated circuit, a device or other electronics or semiconductor component.

While the use of particular transistors are described herein, other transistors (or equivalent devices) may be used instead with little or no change to the remaining circuitry. For example, a field effect transistor (“FET”) (such as an n-channel FET (NFET) or a p-channel FET (PFET)), a bipolar junction transistor (BJT—e.g., NPN transistor or PNP transistor), insulated gate bipolar transistors (IGBTs), and/or junction field effect transistor (JFET) may be used in place of or in conjunction with the devices disclosed herein. The transistors may be depletion mode devices, drain-extended devices, enhancement mode devices, natural transistors or other types of device structure transistors. Furthermore, the devices may be implemented in/over a silicon substrate (Si), a silicon carbide substrate (SiC), a gallium nitride substrate (GaN) or a gallium arsenide substrate (GaAs).

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter.

While the foregoing is directed to specific examples, other and further examples may be devised without departing from the basic scope thereof, and the scope thereof is determined by the claims that follow.

What is claimed is:

1. A device, comprising:
an excitation circuit having a first output terminal and a second output terminal, the first output terminal configured to provide a first signal of a first frequency to a capacitive sensor, the second output terminal configured to provide a second signal of a second frequency to the capacitive sensor;
a monitoring circuit having an input terminal configured to receive a third signal from the capacitive sensor in response to the first and second signals; and
a control circuit configured to control the first frequency of the first signal and the second frequency of the second frequency to determine a value of the third signal.

2. The device of claim 1, wherein the monitoring circuit comprises a sampling circuit having an input terminal and an output terminal, the output terminal configured to provide an output signal representing the third signal.

3. The device of claim 2, wherein the monitoring circuit comprises an amplification circuit having an input terminal and an output terminal, the output terminal coupled to the input terminal of the sampling circuit.

4. The device of claim 3, wherein the amplification circuit comprises a first capacitor, a second capacitor, and an operational amplifier having a first input terminal, a second input terminal, and an output terminal, the first capacitor coupled between the input terminal of the amplification circuit and the first input terminal of the operational amplifier, the second capacitor coupled between the first input terminal of the operational amplifier and the output terminal of the operational amplifier, and the output terminal of the operational amplifier coupled to the output terminal of the amplification circuit.

5. The device of claim 4, wherein the second input terminal of the operational amplifier is configured to receive an input voltage.

6. The device of claim 3, wherein the monitoring circuit comprises a low pass filter (LPF) having a first terminal and a second terminal, the first terminal configured to receive the third signal of the capacitive sensor, the second terminal coupled to the input terminal of the amplification circuit.

7. The device of claim 2, wherein the monitoring circuit comprises a comparison circuit configured to provide an output signal based on between the output signal of the sampling circuit and a reference signal.

8. The device of claim 7, wherein the comparison circuit comprises a comparator having a first input terminal, a second input terminal, and an output terminal, the first input terminal coupled to the output terminal of the sampling circuit, the second input terminal configured to receive the reference signal, and the output terminal configured to provide the output signal.

9. The device of claim 7, wherein the control circuit comprises a tracking circuit configured to determine the value of the third signal based on the reference signal and the output signal of the comparison circuit.

10. The device of claim 9, wherein to determine the value of the third signal, the tracking circuit is configured to:
adjust the first frequency of the first signal and the second frequency of the second signal;
determine whether to conclude adjustment of the first frequency and the second frequency based on the output signal of the comparison circuit; and
based on determining to conclude the adjustment, determine the value of the third signal based on a value of the reference signal.

11. The device of claim 10, wherein the control circuit is configured to determine a value of acceleration based on the value of the third signal, the first frequency, and the second frequency.

12. The device of claim 11, wherein the capacitive sensor is a capacitive accelerometer, and wherein the device is associated with a tire pressure monitoring system (TPMS).

13. The device of claim 1, wherein the first signal is a first pulse-shaped signal, and the second signal is a second pulse-shaped signal, wherein the first frequency is equal to the second frequency, and wherein the first pulse-shaped signal is out of phase relative to the second pulse-shaped signal.

14. The device of claim 1, wherein the capacitive sensor comprises a first capacitance between a first terminal and a third terminal, and a second capacitance between the third terminal and a second terminal, the first terminal coupled to the first output terminal of the excitation circuit, the second terminal coupled to the second output terminal of the excitation circuit, and the third terminal coupled to an input terminal of the monitoring circuit.

15. A method, comprising:
providing a first signal of a first frequency and a second signal of a second frequency to a capacitive sensor to generate a third signal;
receiving the third signal from the capacitive sensor; and
controlling the first frequency of the first signal and the second frequency of the second signal to determine a value of the third signal.

16. The method of claim 15, comprising:
generating a sample based on the third signal; and
comparing the sample with a value of a reference signal to generate a comparison result.

17. The method of claim 16, wherein controlling the first frequency of the first signal and the second frequency of the second signal to determine a value of the third signal comprises:
adjusting the first frequency of the first signal and the second frequency of the second signal to cause a change to the third signal;
determining whether to conclude adjustment of the first frequency and the second frequency based on the comparison result; and
based on determining to conclude the adjustment, determine the value of the third signal based on the value of the reference signal.

18. The method of claim 17, further comprising:
determining a value of acceleration based on the determined value of the third signal, the first frequency, and the second frequency.

19. The method of claim 18, the capacitive sensor is a capacitive accelerometer of a tire pressure management system (TPMS).

20. The method of claim 15, wherein the first signal is a first sinusoidal signal, and the second signal is a second sinusoidal signal, wherein the first frequency is equal to the second frequency, and wherein the first sinusoidal signal is out of phase relative to the second sinusoidal signal.
